(19) United States
(12) Patent Application Publication
(10) Pub. No.: US 2026/0300138 A1
(43) Pub. Date: Oct. 1, 2026

(54) METHOD FOR CHECKING DATA OF A TECHNICAL SYSTEM IN THE COURSE OF A PERFORMANCE OF A SOFTWARE SERVICE

(71) Applicant: Robert Bosch GmbH, Stuttgart (DE)

(72) Inventors: Oleg Schell, Krautheim (DE); Sebastian Paul, Stuttgart (DE)

(21) Appl. No.: 19/573,100

(22) Filed: Mar. 20, 2026

(30) Foreign Application Priority Data
Mar. 25, 2025 (DE) 10 2025 111 372.6

(51) Int. Cl. G06F 11/3668

(52) U.S. Cl. CPC G06F 11/3672

(57) ABSTRACT

A method for checking data of a technical system in the course of a performance of a software service. The method includes: receiving the data of the technical system in encrypted form by an external data processing device, wherein the data are provided for the execution of the software service; providing metadata by the external data processing device, wherein the metadata characterize a transmission of the technical system; transmitting the provided metadata to a validation module; initiating a validation of the data with regard to consistency and/or plausibility based on an analysis of the provided metadata by the validation module; initiating a performance of at least one measure according to a result of the validation by the validation module, wherein the at least one measure, in the case in which the validation indicates that the data are consistent and/or plausible, includes forwarding the data to the software service.

### CROSS REFERENCE

The present application claims the benefit under 35 U.S.C. § 119 of Germany Patent Application No. DE 10 2025 111 372.6 filed on Mar. 25, 2025, which is expressly incorporated herein by reference in its entirety.

### FIELD

The present disclosure relates to a method for checking data of a technical system in the course of a performance of a software service. The present disclosure furthermore relates to a computer program, a device, and a storage medium for this purpose.

### BACKGROUND INFORMATION

The topic of cybersecurity is becoming increasingly important in various fields such as mobility, healthcare or consumer applications. With the increasing networking of everyday products through the development of innovative functions and the further development of wireless technologies such as 6G, the number of attack vectors is also increasing, which is bringing new possibilities for attackers and new challenges for security experts. On the other hand, the networking and digitization of physical entities such as vehicles or infrastructures are leading to the generation and availability of large quantities of data, which are either processed by the entity itself or transmitted via wireless interfaces to remote or edge servers. The connection and data transmission to servers can provide advantages in relation to extended functions for the respective entities or the monitoring of their performed methods and states.

However, the processing of data of other entities entails risks that cannot be handled by state-of-the-art proactive security measures such as digital signatures or certificate-based authentication. Essentially, attackers within the system can send data that appear valid due to correct digital signatures and certificates, but the contained data can nevertheless be malicious in order to harm others or to gain an advantage for the data. A future scenario in which such attacks must be taken into account is digital twin platforms that provide safety-critical software services, such as for example automated driving scenarios (e.g., intersection management).

Future safety-critical scenarios of automated driving, such as for example cooperative intersection management, will require methods for evaluating the trustworthiness of the participating physical entities. A crucial part of such trust evaluations is the detection of misbehavior, which aims at detecting malicious nodes either via node-centric or data-centric mechanisms or a combination of both.

One approach in data-centric mechanisms is an autonomous environment in which messages from the same sender are checked for invalid behavior, often involving the vehicle's own sensor. In a collaborative environment, messages from different sources are combined and checked for consistency and deviations. Both approaches have their disadvantages: autonomous detection mechanisms are often inaccurate, whereas collaborative mechanisms depend on the existence of a majority.

In other approaches, probabilistic filters are used in order to detect malfunctioning nodes by checking incoming messages from other vehicles. In this case, however, location-based vehicle data are used, i.e. filtering must be carried out locally on the participating vehicles. In addition, for detecting misbehavior there is a mechanism that exploits signal characteristics such as the received signal strength indicator (RSS). In this case, a basic safety message (BSM) is considered - a very specific type of message within the V2X standard. Here, too, work must be performed locally on the participating entities.

Furthermore, it has also been shown that signal characteristics can be used either for validating own estimations, such as for example the position, or for central optimization of entire networks. For example, there is a method that makes it possible for mobile users to validate their own position via validation techniques based on the characteristics of the received radio signals (e.g. calculation of the mean value and the standard deviation of the received signal strength). Furthermore, signal characteristics and sensor information can be used to improve a performance of a radio network.

### SUMMARY

The present disclosure relates to a method, a computer program, a device, and a computer-readable storage medium having certain features of the present disclosure. Further features and details are disclosed herein. Features and details that are described in connection with the method according to the present disclosure of course also apply in connection with the computer program according to the present disclosure, the device according to the present disclosure, and the computer-readable storage medium according to the present disclosure, and vice versa in each case, so that mutual reference can also always be made with regard to the present disclosure.

In particular, the subject-matter of the present disclosure is a method for checking data of a technical system, for example of a vehicle or a traffic infrastructure, in the course of performing a software service, for example a driving function or a multimedia function, in particular within the framework of at least partially automated driving. According to an example embodiment, the method comprises:

receiving the data of the technical system in encrypted form by an external data processing device, in particular a trusted infrastructure such as, for example, a base station or also an edge-computing platform or a server, wherein the data are provided for the executionperformance of the software service, wherein the data can comprise sensor data resulting from a detection by at least one sensor of the vehicle, and wherein the encrypted form can be provided, for example, by shared credentials on a universal subscriber identity module (USIM) of the technical system and of a corresponding network operator of the external data processing device,

providing metadata by the external data processing device, wherein the metadata characterize a transmission, in particular a quality of the transmission, of the technical system,

transmitting the provided metadata to a validation module, wherein the validation module can be provided on the external data processing device or on a further external data processing device,

initiating a validation of the data with regard to consistency and/or plausibility on the basis of an analysis of the provided metadata by the validation module, wherein, for example, comparison data for the data can be ascertained on the basis of the metadata, such as for example a position of the technical system, in order to carry out the validation on the basis of the comparison data,

initiating a performance of at least one measure according to a result of the validation by the validation module, wherein the at least one measure, in the case in which the validation indicates that the data are consistent and/or plausible, comprises forwarding the data to the software service.

In this way, it is possible to ensure that a reliable checking of the data of the technical system can be guaranteed before the data are used for the performance of the software service. By a dedicated module integrating the metadata and the validation, it can be ensured that the data are consistent and plausible. This contributes in particular to increased safety of the technical system and surrounding technical systems, since unreliable or manipulated data, which may indicate attacks, can be recognized and appropriate measures can be taken. The selection of the location of the validation module can be carried out depending on the requirements of the specific application or infrastructure. For example, it could be implemented in a cloud-based environment on a separate external data processing device in order to achieve better scalability and resource distribution. Alternatively, it can be integrated directly on the external data processing device that receives the data of the technical system, which could lead to lower latency.

It can also be possible for the metadata to characterize signal characteristics in the course of transmission and to include at least one of the following items of information:

a received signal strength (RSSI, received signal strength indicator),

a total received power,

a received interference power,

a path loss,

a latency,

a data transmission rate,

a signal-to-interference-plus-noise ratio (SINR),

a jitter value.

As a result, the validation of the data by the validation module can be carried out with the aid of a comprehensive dataset. The use of the signal characteristics as metadata makes possible, in particular, an accurate assessment of the consistency and plausibility of the transmitted data. This can lead to increased security of the technical system, since, for example, manipulated or falsified data can be detected due to a deviation from the expected signal characteristics. In addition to the signal characteristics, the metadata can also include, for example, a transmission address and/or reception address or a size of individual data packets of the data.

In addition, it can be advantageous within the scope of the present disclosure for the metadata to comprise sensor data, wherein the sensor data result from a detection by at least one sensor of the external data processing device. The sensor data can, for example, enable a conclusion to be drawn regarding a speed of vehicles at intersections, a number of vehicles, and/or a position of vehicles in an environment of the external data processing device. In this way, it is possible for the validation module to evaluate the accuracy and reliability of the received data by comparison with the sensor data. This makes a more accurate analysis of the consistency and plausibility of the data possible, since additional information about the state of the technical system is available. The integration of the sensor data into the validation can thus contribute to improved safety and reliability of the software service.

Preferably, the metadata can be provided in such a way that they are added to corresponding protocol fields, e.g., header fields, on a particular protocol layer, e.g. a network layer, of the data, or that the metadata are transmitted independently of the data to the validation module. In this way, it is possible for the metadata to be integrated directly into the data. Alternatively, a separate data channel can be used for the metadata, as a result of which an efficient separation of data and metadata can be provided.

Furthermore, it is possible that the at least one measure, in the case in which the validation indicates that the data are not consistent and/or not plausible, is selected from:

initiating a (first) output to the technical system, wherein the (first) output comprises a warning in order to inform the technical system of anomalous behavior,

initiating a (second) output to at least one further technical system at a defined distance from the technical system, wherein the (second) output comprises a warning in order to inform the at least one further technical system of the anomalous behavior of the technical system,

initiating a blocking of an access of the technical system to the external data processing device and/or to the software service.

With the method according to the present disclosure, potential security threats can thus be identified at an early stage and suitable countermeasures can be taken. This can minimize the impact of attacks on technical systems and increase the security of the entire network. The warnings can contribute to ensuring that affected technical systems or users of the technical systems are informed of the problem and can take steps for remediation, such as visiting a repair shop in the case of the technical system or, in the case of the at least one further technical system, suppressing communication with the technical system.

According to a further advantage, the technical system is a vehicle and the external data processing device is a base station, wherein the data comprise a position of the vehicle and the metadata comprise a position of the vehicle estimated by the external data processing device on the basis of signal characteristics in the course of transmission, wherein, in the course of validation, the position of the data is compared with the estimated position. It can thus be ascertained on the basis of the comparison of the positions whether the vehicle is actually located at the position indicated in the data. As a result, inconsistent data and consequently potential attackers can be identified.

It is possible for the method according to the present disclosure to be used in a vehicle. The vehicle can be designed, for example, as a motor vehicle and/or passenger vehicle and/or as an at least partially automated/autonomous vehicle. The vehicle may comprise a vehicle device, for example for providing an autonomous driving function, and/or a driver assistance system. The vehicle device may be designed to at least partially automatically control and/or accelerate and/or brake and/or steer the vehicle.

The present disclosure also relates to a computer program, in particular a computer program product, comprising commands which, when the computer program is executed by at least one computer, cause the computer to carry out the method according to the present disclosure. The computer program according to the present disclosure thus delivers the same advantages as have been described in detail with reference to a method according to the present disclosure.

The present disclosure also relates to a data processing device configured to carry out the method according to the present disclosure. For example, at least one computer which executes the computer program according to the present disclosure can be provided as the device. The computer may have at least one processor for executing the computer program. A non-volatile data memory may also be provided, in which the computer program is stored and from which the computer program can be read by the processor for execution.

The present disclosure may also relate to a computer-readable storage medium which comprises the computer program according to the present disclosure and/or commands which, when executed by at least one computer, cause the computer to carry out the method according to the present disclosure. The storage medium is formed, for example, as a data memory such as a hard drive and/or a non-volatile memory and/or a memory card. The storage medium may be integrated into the computer, for example.

Furthermore, the method according to the present disclosure may also be designed as a computer-implemented method. Alternatively or additionally, at least one of the disclosed method steps may be computer-implemented and/or performed automatically.

Further advantages, features and details of the present disclosure can be found in the following description, in which exemplary embodiments of the present disclosure are described in detail with reference to the figures. The features mentioned herein may be essential to the present disclosure in each case, either individually or in any combination.

### BRIEF DESCRIPTION OF THE DRAWINGS

FIG. 1 shows a schematic visualization of a method, a technical system, an external data processing device, a device, a storage medium and a computer program according to exemplary embodiments of the present disclosure.

FIG. 2 shows a schematic representation of an architecture according to exemplary embodiments of the present disclosure.

FIG. 3 shows a schematic representation of an architecture according to exemplary embodiments of the present disclosure.

### DETAILED DESCRIPTION OF EXAMPLE EMBODIMENTS

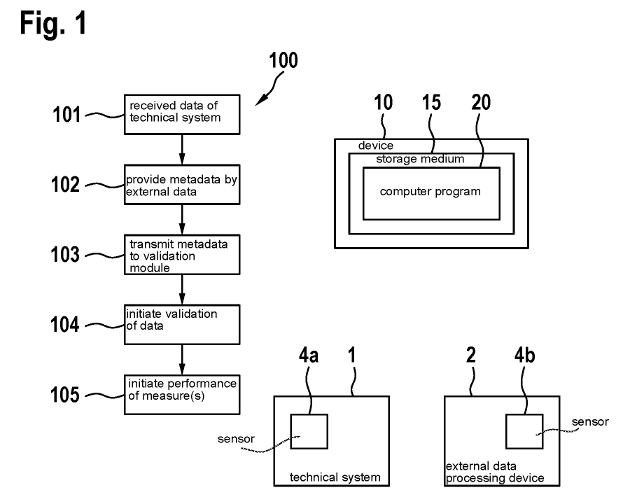

In FIG. 1, a method 100, a technical system 1 having a sensor 4a, an external data processing device 2 having a sensor 4b, a device 10, a storage medium 15 and a computer program 20 according to exemplary embodiments of the present disclosure are shown schematically.

FIG. 1 shows in particular an exemplary embodiment of a method 100 for checking data of a technical system 1 in the course of a performance of a software service. In a first step 101, the data of the technical system 1 are received in encrypted form by an external data processing device 2, wherein the data are provided for the performance of the software service. In a second step 102, metadata are provided by the external data processing device 2, wherein the metadata characterize a transmission of the technical system 1. In a third step 103, the provided metadata are transmitted to a validation module 3. In a fourth step 104, a validation of the data with regard to consistency and/or plausibility is initiated on the basis of an analysis of the provided metadata by the validation module 3. In a fifth step 105, the performance of at least one measure is initiated according to a result of the validation by the validation module 3, wherein the at least one measure, in the case in which the validation indicates that the data are consistent and/or plausible, comprises forwarding the data to the software service.

Starting from scenarios for insider attacks, i.e. attacks within a network, the present disclosure according to exemplary embodiments describes a method that makes it possible to validate data received from technical systems via additional context information (e.g. physical signal characteristics) from external data processing devices in the form of trusted infrastructures such as base stations - including suitable response mechanisms. Insider attacks are, in particular, attacks by supposedly legitimate entities, or technical systems, that are or have been influenced by malicious actors. These attacks in particular cannot be recognized by conventional cryptographic mechanisms, since attackers are in possession of secret key material.

In particular, insider attacks are difficult or impossible to detect with currently employed proactive security measures such as symmetric cryptography, digital signatures or certificates, since they are able to send malicious data that appear valid to the receiver (from a cryptographic point of view). By providing false information about their own entity, such as for example a position or a status, attackers may attempt either to harm other users or to gain advantages themselves.

According to exemplary embodiments, the present disclosure is concerned in particular with attack scenarios within software applications, such as for example scenarios with digital mobility twins, by providing a validation mechanism that incorporates trusted metadata, such as for example physical signal characteristics.

With the upcoming 6G mobile communication standard, enormous quantities of data can be sent from entities, such as for example vehicles. Furthermore, more computing-based and sensor-based infrastructures, such as for example base stations and road-side units, can be located in the immediate vicinity of such entities.

This computer/sensor infrastructure can be regarded as more trustworthy than normal users/things, since it is often regarded as "critical infrastructure," which is generally a regulated area that requires a high level of security throughout its life cycle.

According to exemplary embodiments of the present disclosure, a method is therefore provided in particular that makes it possible to integrate metadata from trusted infrastructures, such as for example base stations, into a centralized data validation technique. This can make the performance of a centralized detection of malicious nodes possible so that other entities can be warned immediately and malicious nodes can be removed from the network if they continue to send malicious data.

According to exemplary embodiments of the present disclosure, trusted infrastructures, e.g. base stations, are enabled to enrich data of technical systems with trusted radio network or sensor information, so that a centralized validation module can check the received data. This can be achieved either by directly adding context information to data packets, e.g. in header fields, as a result of which a direct connection between the data and the technical system is established, or by sending additional context information to the validation module, as a result of which an indirect linkage between technical systems and the received data within a validation module is made possible. If an internal attacker is identified, the validation module responds, for example, by warning (nearby) other technical systems or preventing malicious technical systems from sending data (e.g. by withdrawing access rights).

The method according to exemplary embodiments of the present disclosure can provide a plurality of improvements over what is already available in the related art.

Trust anchors are, in particular, an essential prerequisite in today's security concepts. However, in the case of attacks from the inside, proactive security measures provide only limited protection and detection possibilities. Since infrastructures such as base stations are often regarded as "critical infrastructure" and are therefore subject to conservative security regulations, they can be regarded as trust anchors in security concepts. For this reason, they can provide trusted metadata (e.g. about radio networks or sensors) in order to improve the detection of attacks. In this case, different trust levels can be defined depending on the type of infrastructure and the sensor signal. For example, a base station that is protected against physical tampering and hosted by a trusted network operator is more trustworthy than an unprotected edge server equipped with a video camera as an additional environment sensor. For a scenario of automated driving, such as for example cooperative intersection management, in particular at least one trusted infrastructure device is required, preferably a 3GPP-based base station to which all participating physical entities connect as part of a network cell. In this scenario, the base station should preferably also be located in the vicinity of the intersection in order to provide suitable sensor data for the extended validation approach according to the present disclosure. However, the method according to the present disclosure can also be extended to a plurality of trusted infrastructure devices for various other scenarios that require a validation of the received data.

Infrastructure devices, such as base stations, can capture their environment in order either to optimize their own performance or to provide optimized functions to other technical systems or software services. In the case of 3GPP-based base stations, such measurements include for example: received signal strength, total received power, received interference power, path loss, latency, data transmission rate and signal-to-interference-plus-noise ratio (SINR). By providing such additional network information, which can be linked to technical systems, as metadata, a centralized validation module can perform validation checks on the received data. For example, the position of a technical system can be estimated with the aid of network information and compared with the position data received from this technical system. Furthermore, sensors integrated into a trusted infrastructure, such as video, radar, ISAC (integrated sensing and communication), etc., could provide additional sensor information in order to improve the validation within the centralized validation module.

The validation of the received data via trusted metadata according to exemplary embodiments of the present disclosure makes possible, in particular, an efficient detection of attackers. In the above example, a validation algorithm could accordingly detect an intentionally false location, or position, of a technical system.

When attackers are detected, operation is preferably not simply stopped, but other technical systems can actively be protected against the identified attacker. This can be done in various ways: there could be a notification of the affected technical system in order to suppress the sending of false data. Furthermore, neighboring further technical systems could be notified about the detected malicious technical system. In addition, the malicious technical system can be deprived of access to the radio network or utilized software services.

By using functions of 6G, the upcoming mobile communication standard, data (i.e. at the level of network packets) from technical systems can be enhanced with metadata such as inherently trusted environmental sensor signals on the basis of ISAC (e.g. speed of vehicles at intersections, number of vehicles (including identifiers, e.g. SUCI), location of vehicles, etc.) and thus ultimately facilitate a detection of malfunctioning nodes, or technical systems, in centralized validation modules. Furthermore, the method according to the present disclosure benefits in particular from an already existing secure communication channel between technical systems, network infrastructure, or the external data processing device, and network operators, which can make mutual authentication and data confidentiality possible on the basis of shared credentials between technical systems (USIM) and network operators. The mutual authentication between technical systems and the network can be a required feature of the method according to the present disclosure and is in particular not available in other wireless communication technologies, such as for example WiFi.

Compared with what is already available, the approach according to the present disclosure makes possible, in particular, a centralized, autonomous validation of data (i.e. plausibility checks) by securely enriching messages with trusted metadata, e.g. sensor information (e.g. via ISAC-capable base stations), in order to identify potentially malicious technical systems. Such a mechanism could be required in future safety-critical autonomous driving scenarios.

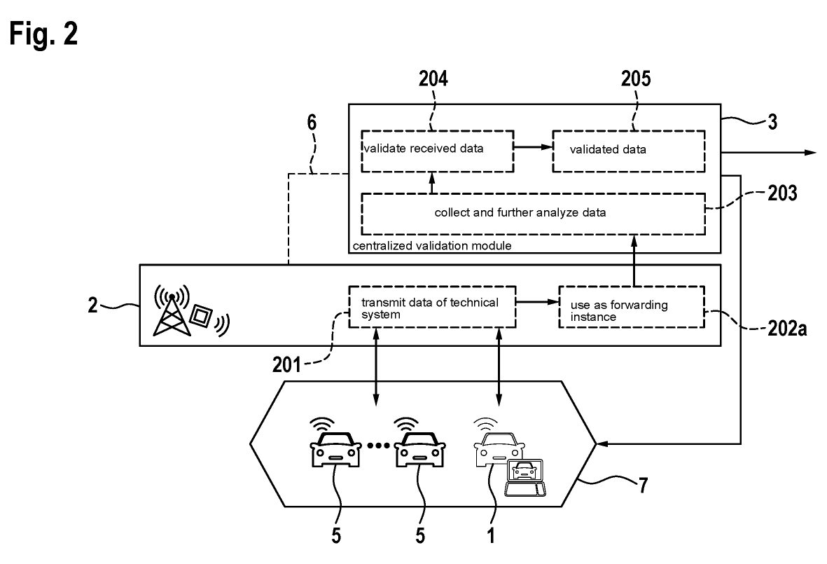

FIG. 2 shows an architecture according to exemplary embodiments of the present disclosure. This can include the following elements:

A technical system 1 and further technical systems 5, which are in particular part of a network cell 7 and continuously send data to software services, such as for example a digital twin platform. Furthermore, the technical systems 1,5 can have an active connection to the trusted infrastructure 2 via wireless communication standards, such as for example 6G.

At least one external data processing device 2, or trusted infrastructure (e.g. a (6G) base station), is in particular capable of providing additional metadata, such as for example signal characteristics or sensor measurements, in order to improve the data validation of messages of technical systems 1,5, e.g. by packet insertion.

A centralized validation module 3 according to the present disclosure can be part of the trusted infrastructure 2 or can be hosted externally by a further external data processing device such as a (cloud) server (not shown), e.g. as part of a digital twin platform. The validation module 3 is in particular responsible for performing a validation check and an identification of insider attacks along with a response thereto (in cooperation with the network operator).

As an initialization step, the validation module 3 can enable the validation according to the present disclosure (i.e. for example the enrichment of data with additional metadata) on the corresponding external data processing device 2 of the trusted infrastructure by a request of either specific technical systems (via identifiers) or of all technical systems in a nearby geographical region (e.g. the entire network cell 7 or a specific intersection).

In a first step 201, data of the technical system 1 can be transmitted via wireless communication technologies such as 6G to an external data processing device 2 of the trusted infrastructure. The transmitted data are preferably encrypted with cryptographic technologies in order to achieve common security goals such as authenticity of sender and receiver, data confidentiality, etc. This can be achieved by shared credentials on the universal subscriber identity module (USIM) of the technical system 1 and of the corresponding network operator. Such strong mutual authentication is in particular also unique to modern 3GPP-based communication protocols such as 6G.

In a second step 202a, the trusted external data processing device 2 can be used as a forwarding instance and enrich the received data packets with required metadata such as RSSI, SINR, path loss, latency, jitter or sensor values, in particular on the basis of ISAC information, by adding the desired values to corresponding protocol fields (e.g. header fields) on the particular protocol layer (e.g. network layer). In particular, this step does not violate security goals on the lower protocol layers, since the infrastructure 2 can read and write data in header or body fields as prescribed in existing standards. Consequently, it can also be permissible to add additional network/sensor information in predefined header or body fields. In this way, a direct correspondence between sender information and context information can be achieved, which can be used in the subsequent validation steps.

After the data packets have been expanded by additional metadata, the data are preferably sent to the validation module 3, where the data can be collected and further analyzed according to step 203. The validation module 3 can either be an application that is part of the infrastructure 2 of a network operator or a third-party application that offers such software services (e.g. a digital twin platform). This requires in particular a secure channel 6 to be established between trusted infrastructure 2 and application, which channel is inherently available in 3GPP-based communication scenarios.

As soon as the validation module 3 receives the expanded data packets, it preferably validates the received data according to step 204 (i.e. it verifies their plausibility and consistency) on the basis of the additional metadata that the trusted out-of-band channel 6 provides to the validation module 3 with the network infrastructure 2. Depending on the type of information, or metadata, provided by the network infrastructure, this step comprises, for example, a calculation and interpretation of statistical or location-based features from the additional metadata before they can be matched with the content of the source message, i.e. the data of the technical system 1. Furthermore, this pre-calculation step could be further improved by a pre-trained machine learning model, or AI model. In alternative approaches, different trust levels can be used for different types of metadata.

After the validation step, the validated data 205 can either be marked as correct and forwarded for further processing to software services, or marked as false, which indicates a potential attack. In this case, technical systems can also be marked as trustworthy or untrustworthy. In the event of an identified attack, there are a plurality of different possibilities for damage mitigation. Firstly, the potentially malicious technical system 1 can be informed that it has been detected and be requested to have itself serviced in an authorized repair shop. Secondly, other nearby technical systems 5 can be warned of the threat from attackers by restricting communication to a minimum or only to non-safety-critical functions. Thirdly, the credentials of the malicious technical system 1 can be revoked, as a result of which the transmission of malicious data is blocked. This close cooperation between the validation module 3 and the network infrastructure 2 constitutes in particular a further advantage of this approach over the related art, since the network infrastructure 2 has a direct influence on the communication capabilities of the technical system 1.

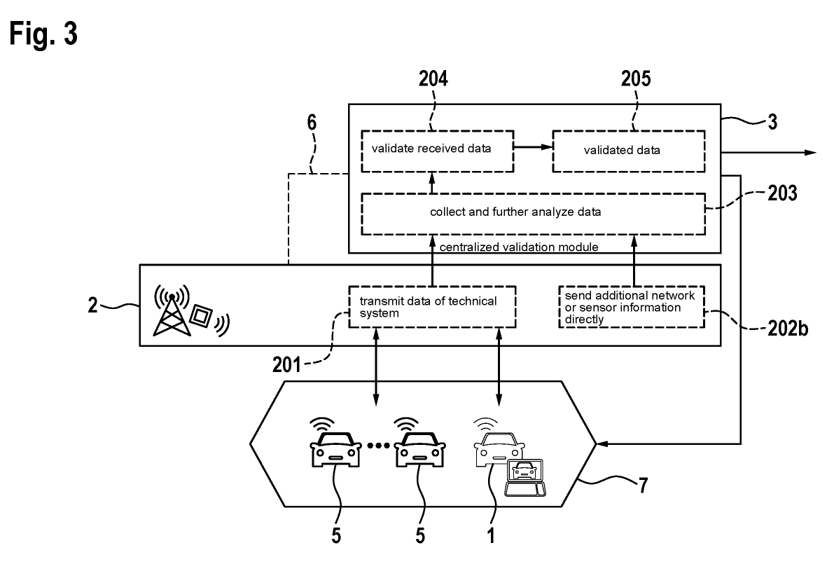

In the event that the trusted infrastructure 2 is not able to add the additional network information, or metadata, directly to the data packets, the following alternative solution can be performed (see FIG. 3). In a parallel communication channel, according to step 202b the trusted external data processing device can in this case send its additional network or sensor information directly to the validation module 3. Consequently, the matching between the network information and the received data is carried out in particular within the validation module 3.

The above description of the embodiments describes the present disclosure exclusively in the context of examples. Of course, individual features of the embodiments, provided they are technically feasible, can be freely combined with one another without departing from the scope of the present disclosure.

What is claimed is:

1. A method for checking data of a technical system in the course of a performance of a software service, the method comprising:
receiving the data of the technical system in encrypted form by an external data processing device, wherein the data are provided for execution of the software service;
providing metadata by the external data processing device, wherein the metadata characterize a transmission of the technical system;
transmitting the provided metadata to a validation module;
initiating a validation of the data with regard to consistency and/or plausibility based on an analysis of the provided metadata by the validation module; and
initiating a performance of at least one measure according to a result of the validation by the validation module, wherein the at least one measure, when the validation indicates that the data are consistent and/or plausible, includes forwarding the data to the software service.

2. The method according to claim 1, wherein the validation module is provided on the external data processing device or on a further external data processing device.

3. The method according to claim 1, wherein the metadata characterize signal characteristics in the course of transmission and include at least one of the following items of information:
a signal strength,
a total received power,
a received interference power,
a path loss,
a latency,
a data transmission rate,
a signal-to-interference-plus-noise ratio,
a jitter value.

4. The method according to claim 1, wherein the metadata include sensor data, wherein the sensor data result from a capture by at least one sensor of the external data processing device.

5. The method according to claim 1, wherein the metadata are provided in such a way that: (i) the metadata are added to corresponding protocol fields on a particular protocol layer of the data, or (ii) the metadata are transmitted independently of the data to the validation module.

6. The method according to claim 1, wherein, when the validation indicates that the data are not consistent and/or not plausible, the at least one measure, is selected from:
initiating an output to the technical system, wherein the output includes a warning to inform the technical system of anomalous behavior,
initiating an output to at least one further technical system at a defined distance from the technical system, wherein the output includes a warning to inform the at least one further technical system of anomalous behavior of the technical system,
initiating a blocking of an access of the technical system to the external data processing device and/or to the software service.

7. The method according to claim 1, wherein:
the technical system is a vehicle, and the external data processing device is a base station,
the data include a position of the vehicle, and the metadata include an estimated position of the vehicle estimated by the external data processing device based on signal characteristics in the course of the transmission,
in the course of the validation, the position of the vehicle is compared with the estimated position.

8. A data processing device configured to check data of a technical system in the course of a performance of a software service, the data processing device configured to perform the following steps comprising:
receiving the data of the technical system in encrypted form by an external data processing device, wherein the data are provided for execution of the software service;
providing metadata by the external data processing device, wherein the metadata characterize a transmission of the technical system;
transmitting the provided metadata to a validation module;
initiating a validation of the data with regard to consistency and/or plausibility based on an analysis of the provided metadata by the validation module; and
initiating a performance of at least one measure according to a result of the validation by the validation module, wherein the at least one measure, when the validation indicates that the data are consistent and/or plausible, includes forwarding the data to the software service.

9. A non-transitory computer-readable storage medium on which are stored comprising commands for checking data of a technical system in the course of a performance of a software service, the commands, when executed by at least one computer, causing the at least one computer to perform the following steps comprising:
receiving the data of the technical system in encrypted form by an external data processing device, wherein the data are provided for execution of the software service;
providing metadata by the external data processing device, wherein the metadata characterize a transmission of the technical system;
transmitting the provided metadata to a validation module;
initiating a validation of the data with regard to consistency and/or plausibility based on an analysis of the provided metadata by the validation module;
initiating a performance of at least one measure according to a result of the validation by the validation module, wherein the at least one measure, when the validation indicates that the data are consistent and/or plausible, includes forwarding the data to the software service.
